(19) United States
(12) Patent Application Publication
(10) Pub. No.: US 2007/0146968 A1
(43) Pub. Date: Jun. 28, 2007

(54) SEPARATOR FOR INSULATING POSITIVE ELECTRODE AND NEGATIVE ELECTRODE

(75) Inventors: Hidetoshi Ohta, Kanagawa (JP); Keiichi Hayashi, Kanagawa (JP); Takashi Tanikawa, Kanagawa (JP); Atsushi Shimizu, Kanagawa (JP)

Correspondence Address: HARNESS, DICKEY & PIERCE, P.L.C., P.O. BOX 828, BLOOMFIELD HILLS, MI, 48303, US

(73) Assignee: Power Systems Co., Ltd., Yokohama-shi (JP)

(21) Appl. No.: 11/613,208

(22) Filed: Dec. 20, 2006

(30) Foreign Application Priority Data
Dec. 27, 2005 (JP) 2005-375327

(51) Int. Cl. H01G 9/02; H01G 9/042; B32B 25/06; B05D 5/00

(52) U.S. Cl. 361/502; 428/496; 427/243

(57) ABSTRACT

The present invention provides a separator for insulating a positive electrode and a negative electrode, the separator having mechanical strength and oxidation-reduction resistance while being excellent in impregnatability with an electrolytic solution and ion mobility like conventional cellulose-containing separators for insulating a positive electrode and a negative electrode. A separator for insulating a positive electrode and a negative electrode, wherein the separator comprises a porous sheet containing cellulose and a latex with which the porous sheet is impregnated.

### BACKGROUND OF THE INVENTION

1. Field of the Invention

The present invention relates to separators for insulating a positive electrode and a negative electrode in an electronic part, and particularly to separators for insulating a positive electrode and a negative electrode in an electronic part in which the electrodes are soaked in an electrolytic solution.

2. Description of the Related Art

In electronic parts such as electric double layer capacitors, nonaqueous cells and electrolytic capacitors, a separator made of porous sheet is used in order to hold an electrolytic solution and to insulate a pair of positive and negative electrodes.

For example, Michio Okamura “Electric Double Layer Capacitors and Power Storage Systems” 2nd Edition, The Nikkan Kogyo Shimbun, Ltd., 2001, pages 34 to 37 discloses an electric double layer capacitor comprising a bath partitioned into two sections with a separator, an organic electrolytic solution filled in the bath and two carbonaceous electrodes, one electrode being soaked in one section of the bath and the other being soaked in the other section of the bath. The organic electrolytic solution is a solution containing a solute dissolved in an organic solvent. Tetraethylammonium tetrafluoroborate (Et₄NBF₄) and the like are disclosed as solutes and propylene carbonate is disclosed as a solvent. As such carbonaceous electrodes, activated carbon is employed. The activated carbon refers to shapeless carbon which has a very large specific surface area due to innumerable fine pores present therein. In the present specification, shapeless carbon having a specific surface area of about 1000 m²/g or more is referred to as activated carbon. As the material of the separator for insulating a positive electrode and a negative electrode, nonwoven fabrics made of cellulose, glass fiber and the like are disclosed.

Japanese Patent Laid-open Publication Nos. Hei 11-317333 and 2002-25867 disclose a nonporous carbonaceous material as a polarizable electrode for use in electric double layer capacitors. The carbonaceous material comprises graphite-like microcrystalline carbon and has a specific surface area smaller than that of activated carbon. It is believed that application of voltage to a nonporous carbonaceous material makes electrolyte ions inserted with solvent between layers of graphite-like microcrystalline carbon, resulting in formation of an electric double layer. As the material of a separator for insulating a positive electrode and a negative electrode, glass fiber and Japanese paper are disclosed.

Japanese Patent Laid-open Publication No. 2000-77273 discloses an electric double layer capacitor including nonporous carbonaceous electrodes soaked in an organic electrolytic solution. The organic electrolytic solution must have ion conductivity, and therefore the solute is a salt composed of a cation and an anion combined together. As the cation, lower aliphatic quaternary ammonium, lower aliphatic quaternary phosphonium, imidazolium and the like are disclosed. As the anion, tetrafluoroboric acid, hexafluorophosphoric acid and the like are disclosed. The solvent of the organic electrolytic solution is a polar aprotic organic solvent. Specifically, ethylene carbonate, propylene carbonate, γ-butyrolactone, sulfolane and the like are disclosed.

Japanese Patent Laid-open Publication No. 2005-294780 discloses a carbonaceous material containing graphite as polarizable electrodes for use in electric double layer capacitors. In this carbonaceous material, the rate of change of voltage becomes smaller than that in a voltage change curve based on a time constant at the middle of charging due to the adsorption of ions in an electrolytic solution. Thus, charging/discharging due to adsorption and desorption of ions is conducted. As the material of a separator for insulating a positive electrode and a negative electrode, porous sheet produced from cellulose is disclosed.

Japanese Patent Laid-open Publication No. Hei 10-256088 discloses use of a porous sheet produced from cellulose for a separator for insulating a positive electrode and a negative electrode of an electric double layer capacitor. Such a porous sheet produced from cellulose is excellent in impregnatability with an electrolytic solution and also in ion mobility, and therefore can hold the internal resistance of an electric double layer capacitor at a low level. However, cellulose deteriorates readily in response to the influence of an oxidation-reduction reaction. Therefore, separators containing cellulose are poor in durability. This tendency will become remarkable when the temperature of the environment where the electric double layer capacitor is used becomes high. That is, a lapse of time will render voltage drop, short circuit and the like easier to occur.

Particularly, some carbonaceous electrodes resulting from use of nonporous carbonaceous material or graphite type carbonaceous material exhibit some volume change at the time of charging/discharging, and their rated voltages are high. Therefore, conventional separators for insulating a positive electrode and a negative electrode prepared from cellulose are unsatisfactory with respect to mechanical strength and chemical stability.

### SUMMARY OF THE INVENTION

The present invention intends to solve the aforementioned existing problems. The object of the present invention is to provide a separator for insulating a positive electrode and a negative electrode, the separator having mechanical strength and oxidation-reduction resistance while being excellent in impregnatability with an electrolytic solution and ion mobility like conventional cellulose-containing separators for insulating a positive electrode and a negative electrode.

The present invention provides a separator for insulating a positive electrode and a negative electrode, wherein the separator comprises a porous sheet containing cellulose and a latex with which the porous sheet is impregnated. This can attain the above-mentioned object.

The separator for insulating a positive electrode and a negative electrode of the present invention is excellent in mechanical strength and oxidation-reduction resistance as well as in impregnatability with an electrolytic solution and ion mobility. For this reason, when it is used in an electric double layer capacitor, for example, a low internal resistance and a high durability, especially a high durability in a high temperature environment, will be realized.

### BRIEF DESCRIPTION OF THE DRAWING

FIG. 1 is an assembling diagram showing the structure of the electric double layer capacitor of the Examples. In the figure, 1 or 11 is an insulation washer; 2 is a top cover; 3 is a spring; 4 or 8 is a current collector; 5 or 7 is a carbonaceous electrode; 6 is a separator; 9 is a guide; 10 or 13 is an o-ring; 12 is a body; 14 is a pressing plate; 15 is a reference electrode; and 16 is a bottom cover.

### DETAILED DESCRIPTION OF THE INVENTION

The porous sheet containing cellulose may be any one conventionally used as a separator for insulating a positive electrode and a negative electrode of an electronic part. Examples thereof include a felt-like or mesh-like sheet composed mainly of cellulose fiber, and specifically paper such as Japanese paper and mixed paper.

What is particularly preferable among such materials is a paper material obtained by preparing wet paper from cellulose and drying the wet paper while maintaining void structure present therein. The paper material maintains fine through holes as passages through which ions pass and therefore it is porous and has a high air resistance. For example, paper with a thickness of 100 μm or less which exerts an air resistance of about 1000 seconds/100 cc is preferred.

The thickness of the paper material is preferably within the range of from 20 to 100 μm. If the thickness is less than 20 μm, it will be difficult to handle the material because of its reduced mechanical strength, and therefore there is a danger of internal short circuit. On the other hand, if the thickness is greater than 100 μm, downsizing is impossible and the electric resistance will increase with the increase in the thickness. In the case of a coin type electric double layer capacitor, there will be a high probability of occurrence of short circuit during press molding unless the separator has some degree of thickness. In the case of coin type electric double layer capacitors, therefore, a thickness of up to 100 μm is required.

The density of the paper material is not particularly limited, but it is preferably from 0.3 to 0.6 g/cm³ for practical use. If the density is less than 0.3 g/cm³, the paper material will have an extremely reduced tensile strength and therefore it lacks practicality. It is noted that there is substantially no probability that the paper material has a density more than 0.6 g/cm³ because its void structure is maintained. When the thickness of a separator is limited in practical application, it is also permissible to reduce the thickness of the paper material and adjust the density thereof within the range of from 0.6 to 0.8 g/cm³ by calendering the paper material.

The latex with which the porous sheet containing cellulose is to be impregnated is a stable colloidal dispersion system comprising an aqueous medium and a polymer dispersing therein. This latex preferably contains an acid-modified latex. Although the reason is not clear, it is conceivable that an acid-modified latex interacts with hydroxyl groups of cellulose to reinforce the structure of a sheet and, at the same time, it blocks hydroxyl groups to improve the oxidation-reduction resistance. A preferable latex is one having a pH of from 4 to 10.

The acid-modified latex may be one containing, as an ingredient, a rubber selected from the group consisting of NBR, SBR, acrylic rubber, fluororubber and IIR. Specifically, the acid-modified latex may include a polymer resulting from polymerization using an acidic monomer.

The acidic monomer which serves as a raw material of such a latex may be any one which shows a pH of less than 7 at 20° C. when one gram of the monomer is dissolved in water or mixed with water. Preferable examples thereof include ethylenically unsaturated carboxylic acid monomers. It is particularly preferable to use an ethylenically unsaturated carboxylic acid monomer, an ethylenically unsaturated carboxylic acid ester monomer and, if necessary, a monomer copolymerizable therewith.

Specific examples of the ethylenically unsaturated carboxylic acid monomer include unsaturated monocarboxylic acid monomers such as acrylic acid and methacrylic acid; and unsaturated dicarboxylic acid monomers such as maleic acid, fumaric acid, citraconic acid, mesaconic acid, glutaconic acid, itaconic acid, crotonic acid and isocrotonic acid. Among these, unsaturated monocarboxylic acids such as acrylic acid and methacrylic acid and unsaturated dicarboxylic acids having 5 or less carbon atoms such as maleic acid and itaconic acid are preferred.

Examples of monomers copolymerizable with such acidic monomers include ethylenically unsaturated carboxylic acid ester monomers, styrene-based monomers, nitrile group-containing monomers, acrylamide-based monomers, methacrylamide-based monomers, glycidyl group-containing monomers, sulfonic acid group-containing monomers and conjugated diene monomers. Specific examples of monomers copolymerizable with the above-mentioned acidic monomers include ethylenically unsaturated carboxylic acid ester monomers such as acrylates, e.g. methyl acrylate, ethyl acrylate, propyl acrylate, isopropyl acrylate, n-butyl acrylate, isobutyl acrylate, n-amyl acrylate, isoamyl acrylate, n-hexyl acrylate, 2-ethylhexyl acrylate, hydroxypropyl acrylate and lauryl acrylate; methacrylates, e.g. methyl methacrylate, ethyl methacrylate, propyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, hydroxypropyl methacrylate, and lauryl methacrylate; crotonates, e.g. methyl crotonate, ethyl crotonate, propyl crotonate, butyl crotonate, isobutyl crotonate, n-amyl crotonate, isoamyl crotonate, n-hexyl crotonate, 2-ethylhexyl crotonate and hydroxypropyl crotonate; amino group-containing methacrylic acid-based monomers, e.g. dimethylaminoethyl methacrylate and diethylaminoethyl methacrylate; alkoxy group-containing methacrylic acid-based monomers, e.g. methoxypolyethylene glycol monomethacrylate; and ethylenically unsaturated carboxylic acid ester monomers of unsaturated dicarboxylic acid monoesters, e.g. monooctyl maleate, monobutyl maleate and monooctyl itaconate (among such ethylenically unsaturated carboxylic acid ester monomers, alkyl(meth)acrylates are preferred, wherein the alkyl moiety has from 1 to 12, preferably from 1 to 8, carbon atom(s)). Other examples include styrene-based monomers, e.g. styrene, α-methylstyrene, β-methylstyrene, p-tert-butylstyrene and chlorostyrene; nitrile group-containing monomers, e.g. acrylonitrile and methacrylonitrile; acrylamide-based monomers, e.g. acrylamide, N-methylolacrylamide and N-butoxymethylacrylamide; methacrlamide-based monomers, e.g. methacrylamide, N-methylolmethacrylamide and N-butoxymethylmethacrylamide; glycidyl group-containing monomers, e.g. glycidyl acrylate, glycidyl methacrylate and allyl glycidyl ether; sulfonic acid group-containing monomers, e.g. sodium styrenesulfonate and acrylamidomethylpropanesulfonic acid; conjugated diene monomers, e.g. 1,3-butadiene, isoprene, 2,3-dimethyl-1,3-butadiene, 1,3-pentadiene and piperylene.

In the preparation of the latex, the weight ratio of the acidic monomer used to the monomer used which is copolymerizable with the acidic monomer, based on the overall amount of the monomers used, is from 0.1:99.9 to 50:50, and preferably from 1:99 to 40:60. A particularly preferable latex is one prepared by using an ethylenically unsaturated carboxylic acid ester monomer and an ethylenically unsaturated carboxylic acid monomer. It is possible to prepare a desirable latex from only the two components. However, besides the ethylenically unsaturated carboxylic acid ester monomer, a monomer copolymerizable with the ethylenically unsaturated carboxylic acid monomer may further be used together.

The polymer in the latex preferably includes, as an ingredient, rubber such as NBR, SBR, acrylic rubber, fluororubber and IIR in addition to the acidic monomer. Preferable examples thereof include copolymers of ethylenically unsaturated carboxylic acid ester monomers and ethylenically unsaturated carboxylic acid monomers and copolymers of ethylenically unsaturated carboxylic acid ester monomers, ethylenically unsaturated carboxylic acid monomers and monomers other than ethylenically unsaturated carboxylic acid monomers or their esters, such as acrylonitrile-1,3-butadiene-methacrylic acid-methyl methacrylate copolymer, styrene-acrylonitrile-1,3-butadiene-itaconic acid-methyl methacrylate copolymer, styrene-acrylonitrile-1,3-butadiene-methyl methacrylate-fumaric acid copolymer, styrene-1,3-butadiene-itaconic acid-methyl methacrylate-acrylonitrile copolymer, styrene-n-butyl acrylate-itaconic acid-methyl methacrylate-acrylonitrile copolymer and 2-ethylhexyl acrylate-methyl acrylate-acrylic acid-methoxy polyethylene glycol monomethacrylate.

In order to enhance the bindability and binding durability of polymer particles, such polymers may be crosslinked with a crosslinking agent. In the use of a crosslinking agent, although its amount varies depending on the reaction conditions, the type of the polymer and the like, it is typically not more than 30% by weight based on the amount of the polymer.

The latex used in the present invention can be obtained by conventional methods, for example, the method disclosed in “Jikken Kagaku Koza (Lectures of Experimental Chemistry)”, vol. 28 (edited by The Chemical Society of Japan, published by Maruzen Co., Ltd.), that is, a method comprising adding water, a dispersing agent, monomers, additives such as a crosslinking agent, and an initiator to a hermetically closable container with a stirrer and a heating apparatus so that a desired composition is achieved, stirring the mixture to disperse or emulsify the composition in the water, and initiating polymerization by increasing the temperature under stirring and the like. Alternatively, the latex can be obtained by a method in which the above-mentioned composition is emulsified and then charged into a hermetically closable container and thereafter reaction is initiated in a manner like that mentioned above.

The shape of polymer particles is not particularly limited, but the diameter of the particles is typically from 0.005 to 1000 μm, preferably from 0.01 to 100 μm, and particularly preferably from 0.05 to 20 μm. If the particle diameter is too large, it becomes difficult for the particles to come in contact with the cellulose fibers, resulting in decrease in mechanical strength or chemical stability of the separator. If the particle diameter is too small, the required amount of the binder becomes so large that the polymer particles may clog void structure in the porous sheet. The particle diameter referred to herein is a value calculated as an average of the maximum lengths of 100 polymer particles in a latex state measured in a transmission electron microscopic photograph.

Since the latex used in the present invention is one obtained by using an acidic monomer, such as an ethylenically unsaturated carboxylic acid monomer, as a monomer as mentioned above, the pH of a latex after polymerization is not higher than pH 4 in almost all cases. Therefore, it is necessary to neutralize the latex. The pH of the latex is adjusted to pH 4.0-10.0, and preferably to pH 6.0-9.0 because if the pH is lower than 4.0 or higher than 10, the performance of electronic parts will be adversely affected.

Commercially available acid-modified latexes may also be used. Examples of preferable commercially available products include “BM-400B” produced by Nippon Zeon Co., Ltd., “XSBR-0696” produced by JSR Corp., and “NA20” and “NA105S” produced by Nippon A&L Inc.

In order to impregnate a porous sheet containing cellulose with a latex, conventional methods of impregnation may be used. The impregnation may be conducted so that a polymer solid is attached in an amount of from 0.5 to 10 parts by weight, preferably from 1 to 5 parts by weight, to 100 parts by weight of a porous sheet by a conventional method, for example, a so-called “dip-squeeze” method in which an impregnation fluid is prepared so as to have a solid content of from 5 to 20% by weight and impregnation is conducted through dipping and squeezing operations and a so-called “kiss-coat” method in which impregnation is conducted with a kiss roll using an impregnation fluid having a solid content of from 20 to 40% by weight.

An intermediate obtained in such a way is then heated to dry. The drying is conducted under ordinary drying conditions, for example, at temperatures from 70° C. to 100° C., for 3 to 30 minutes, followed by pressing as necessary. Thus, an impregnated sheet is obtained.

The resulting impregnated sheet can be used suitably as a separator for insulating a positive electrode and a negative electrode of electronic parts, such as electric double layer capacitors, nonaqueous cells, electrolytic condensers and other power storage elements.

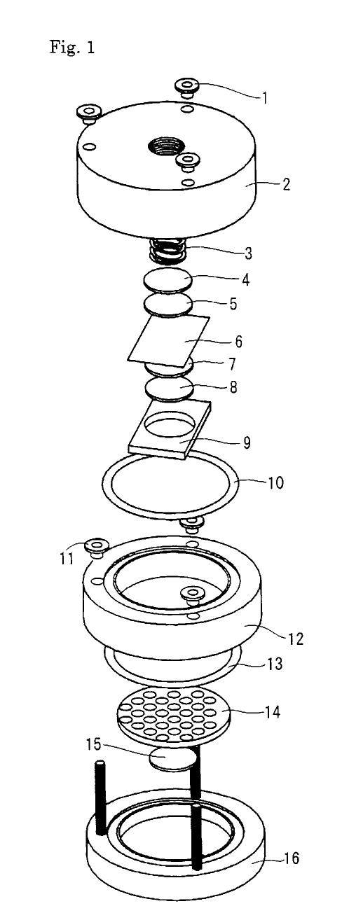

Structures of electric double layer capacitors are shown, for example, in FIGS. 5 and 6 of Japanese Patent Laid-open Publication No. 11-317333, FIG. 6 of Japanese Patent Laid-open Publication No. 2002-25867, and FIGS. 1 to 4 of Japanese Patent Laid-open Publication No. 2000-77273. Generally, such an electric double layer capacitor can be assembled by superposing electrode members via a separator to form a positive electrode and a negative electrode, and then impregnating the electrodes with an electrolytic solution.

As the electrode member, ones having conventionally been used for electric double layer capacitors may be used. For example, an electrode member can be obtained by forming a polarizable electrode using activated carbon particles, nonporous carbonaceous particles and carbonaceous particles containing graphite, followed by joining the polarizable electrode to a current collector.

Preferable nonporous carbon is a carbon powder produced by calcining a carbon raw material at 500-900° C. for 2-4 hours under an inert atmosphere, and then heat-treating in the presence of an alkali hydroxide powder and/or alkali metal. As the carbon raw material, coke green powder, mesophase carbon, infusibilized vinyl chloride and the like may be used.

When petroleum heavy oil obtained during distillation of petroleum is subjected to high temperature pyrolysis treatment, a carbonaceous solid with a needle-like structure is obtained. This solid immediately after generation is called green (raw) needle coke. When used as filler or the like, it is further calcined at a temperature of 1000° C. or higher. The calcined product is called calcined needle coke, which is distinguished from green needle coke. In the present specification, powdery green needle coke is called a needle coke green powder.

For producing nonporous carbonaceous electrodes, it is preferable to use a needle coke green powder as a starting material. Needle coke green powders are easily crystallized even by calcination at relatively low temperatures. Therefore, it is easy to control the ratio of amorphous portions to crystalline portions. Easily graphitizable organic substances are converted into a highly oriented structure through heat treatment and they are easily crystallized even by calcination at relatively low temperatures. Therefore, it is easy to control the ratio of amorphous portions to crystalline portions.

Needle coke green powders are usually produced using petroleum pitch as a raw material. In the present invention, however, coal-origin needle coke green powders produced by removing insolubles in quinoline from a soft pitch of coal and carbonizing the purified raw material may be used. Coal-origin needle coke generally is characterized by a high true specific gravity, a low coefficient of thermal expansion, a needle-like structure and being soft. In particular, it is characterized by a coarser particle size and a lower coefficient of thermal expansion in comparison to petroleum-origin needle coke. Both types of needle cokes are different also in element composition. Contents of sulfur and nitrogen of coal-origin needle coke are lower than those of petroleum-origin needle coke.

In the production of carbonaceous electrodes, a needle coke green powder is prepared first. The central particle diameter of the raw material is from 10 to 5000 μm, and preferably from 10 to 100 μm. Ash in a carbonaceous electrode influences generation of a surface functional group and, therefore, it is important to diminish the content thereof. The needle coke green powder to be used in the present invention includes from 70 to 98% of fixed carbon and from 0.05 to 2% of ash. One having characteristics, namely, a fixed carbon content of from 80 to 95% and an ash content of 1% or less is preferred.

A needle coke green powder is calcined under an inert atmosphere, for example, an atmosphere of nitrogen or argon, at 500-900° C., preferably 600-800° C., and more preferably 600-750° C. for 2-4 hours. It is conceivable that a crystal structure of carbon tissue is formed during this calcination process.

If the calcination temperature is lower than 500° C., pores will grow too much through activation treatment, whereas if it is over 900° C., activation will not progress. The calcination time essentially has no effects on the reaction. When, however, it is approximately less than 2 hours, heat is not transferred throughout the reaction system and, therefore, uniform nonporous carbon is not formed. On the other hand, calcination for over 4 hours is meaningless.

The calcined carbon powder is mixed with from 1.8 to 2.2 times, preferably about 2 times, in weight, of alkali hydroxide. Subsequently, the resulting mixture powder is calcined under an inert atmosphere at 650-850° C., preferably at 700-750° C. for 2-4 hours. This process is called alkali activation and is believed to have an effect of relaxing the crystal structure of carbon through permeation of vapor of alkali metal atoms into carbon tissue.

When the amount of the alkali hydroxide is less than 1.0 time, activation does not progress sufficiently and a capacitance will not develop at the first charging. When the amount of the alkali hydroxide is over 2.5 times, the surface area tends to increase due to too much progress of activation and the surface condition will become the same as that of normal activated carbon. It, therefore, will become difficult to take a withstand voltage. KOH, CsOH, RbOH and the like may be used as the alkali hydroxide. KOH is preferred because it shows excellent activation effects and it is inexpensive.

When the calcination temperature is lower than 650° C., the effect of loosening the carbon layers is diminished due to insufficient permeation of KOH into carbon and, therefore, it is difficult to develop an increase in capacitance at the first charging. When the calcination temperature is higher than 850° C., opposite actions, namely, activation by KOH and crystallization of base carbon, will occur simultaneously and, therefore, it will become difficult to control the activation. The calcination time has no substantial meaning as long as the material is fully heated. If, however, the calcination time is shorter than 2 hours, heat is not distributed sufficiently in the material and some portions are allowed to remain inactivated. On the other hand, calcination for over 4 hours is meaningless.

Subsequently, the resulting mixture powder is washed to remove alkali hydroxide. The washing can be conducted, for example, by recovering particles from the carbon after the alkali treatment, filling the articles in a stainless steel column, introducing compressed steam at a temperature of from 120° C. to 150° C. and a pressure of from 10 to 100 kgf, preferably from 10 to 50 kgf into the column, and continuing the introduction of compressed steam until the pH of the waste water becomes 7 or lower (typically 6 to 10 hours). After the completion of the alkali removing step, an inert gas such as argon and nitrogen is allowed to flow in the column for drying. Thus, a desired carbon powder is obtained.

The carbon powder obtained via the above-mentioned steps has a specific surface area of 300 m²/g or less. This is classified into so-called “nonporous carbon”, which has few pores large enough to capture electrolyte ions, solvent, CO₂ gas and the like therein. The specific surface area can be determined by the BET method using CO₂ as an adsorbate.

As the electrolytic solution, a so-called organic electrolytic solution prepared by dissolving an electrolyte as a solute in an organic solvent may be used. As the electrolyte, substances which are usually used by persons skilled in the art, such as those disclosed in Japanese Patent Laid-open Publication No. 2000-77273, may be used. Specific examples include salts with tetrafluoroboric acid or hexafluorophosphoric acid, of lower aliphatic quaternary ammonium such as triethylmethyl ammonium (TEMA), tetraethylammonium (TEA) and tetrabutylammonium (TBA); lower aliphatic quaternary phosphonium such as tetraethylphosphonium (TEP); or imidazolium derivatives such as 1-ethyl-3-methylimidazolium (EMI).

Particularly preferable electrolytes are salts of pyrrolidinium compounds and their derivatives. Preferable pyrrolidinium compound salts have a structure shown by the formula: 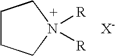
wherein R is each independently an alkyl group or R and R form together an alkylene group, and X⁻ is a counter anion. Pyrrolidinium compound salts are conventionally known and any one prepared by a method known to those skilled in the art may be used.

Preferable ammonium components in the pyrrolidinium compound salts are those wherein in the formula given above R is each independently an alkyl group having from 1 to 10 carbon atoms or R and R form together an alkylene group having from 3 to 8 carbon atoms. More preferable ammonium components are a compound wherein R and R form together an alkylene group having 4 carbon atoms (namely, spirobipyrrolidinium) and a compound wherein R and R form together an alkylene group having 5 carbon atoms (namely, piperidine-1-spiro-1′-pyrrolidinium). Use of such compounds leads to an advantage that the decomposition voltage has a wide potential window and they are dissolved in a large amount in a solvent. The alkylene group may have substituents.

The counter anion X⁻ may be any one which has heretofore been used as an electrolyte ion of an organic electrolytic solution. Examples include a tetrafluoroborate anion, a fluoroborate anion, a fluorophosphate anion, a hexafluorophosphate anion, a perchlorate anion, a borodisalicylate anion and a borodioxalate anion. Preferable counter anions are a tetrafluoroborate anion and a hexafluorophosphate anion.

When the aforesaid electrolyte is dissolved in an organic solvent as a solute, an organic electrolytic solution for electric double layer capacitors is obtained. The concentration of an electrolyte in an organic electrolytic solution is adjusted to from 0.8 to 3.5 mol %, and preferably from 1.0 to 2.5 mol %. If the concentration of the electrolyte is less than 0.8 mol %, the number of ions contained is not sufficient and enough capacitance may not be produced. A concentration over 2.5 mol % is meaningless because it does not contribute to capacitance. Electrolytes may be used alone or as mixtures of two or more kinds of them. Such electrolytes may be used together with electrolytes conventionally employed for organic electrolytic solutions.

As the organic solvent, ones which have heretofore been used for organic electric double layer capacitors may be used. For example, ethylene carbonate (EC), propylene carbonate (PC), γ-butyrolactone (GBL), sulfolane (SL) and the like are preferable because of their high dissolvability of electrolytes and their high safety. Solvents containing these as main solvents and at least one kind of auxiliary solvent selected from dimethyl carbonate (DMC), ethylmethyl carbonate (EMC) and diethyl carbonate (DEC) are also useful because the low-temperature characteristics of electric double layer capacitors are improved. Use of acetonitrile (AC) as an organic solvent is preferable from the viewpoint of performances because it improves conductivity of electrolytic solutions. However, in some cases, applications are restricted.

The present invention will be described in more detail below with reference to Examples, but the invention is not limited thereto. Note that the amounts expressed in “part(s)” or “%” in the Examples are by weight unless otherwise stated.

### EXAMPLES

### Example 1

Pellets of potassium hydroxide were pulverized in a mill into a powder. A coal-origin needle coke green powder (NCGP) produced by The Japan Steel Works, Ltd. was placed in an alumina crucible. It was calcined in a muffle furnace at a temperature given in Table 1 for 3 hours under circulation of nitrogen, and then cooled spontaneously. The calcined product was mixed with 1.5 times in weight of the potassium hydroxide powder. This was divided into nickel crucibles, which were then covered with nickel lids to isolate the external atmosphere. These were activated in a muffle furnace at 750° C. for a retention time of 4 hours under circulation of nitrogen. Each calcined product was taken out and washed with pure water lightly, followed by ultrasonic washing for one minute. Then, water was separated by using a Buchner funnel. The same washing operation was repeated until the pH of washings became about 7. The resultant was dried in a vacuum drier at 200° C. for 10 hours.

Each resulting carbon was pulverized for one hour with 10 mmφ alumina balls in a ball mill (AV-1, manufactured by Fujiwara Scientific Co., Ltd.). Measurement of particle size by a Coulter counter showed that every powder had a central particle diameter of about 10 μm. The specific surface areas of the resulting carbon powders were measured by the BET method and were found to be 80 m²/g. The volume of pores with a pore diameter of 0.8 nm or less was 0.04 ml/g.

Powdery carbon (CB) was mixed with acetylene black (AB) and polytetrafluoroethylene powder (PTFE) so that the mixing ratio became 10:1:1, and then kneaded in a mortar. The PTFE was extended into a flake-like form in about 10 minutes. The flake-like PTFE was pressed with a press machine into a carbon sheet of 200 μm in thickness. This carbon sheet was punched into a disc with a diameter of 20 mmφ. Thus, a positive electrode and a negative electrode were obtained.

A separator paper (“TF4035” produced by NKK Corp. (Nippon Kodoshi Corp.)) and a latex (“BM-400B” produced by Nippon Zeon Co., Ltd.) were prepared. This latex is one composed of an aqueous medium and carboxylic acid-modified acrylonitrile-butadiene rubber particles dispersed therein and having a pH of 6.5.

The separator paper was punched into a disc with a diameter of 20 mmφ. The solid concentration of the latex was adjusted to 5% by use of ion exchange water, and the punched separator paper was immersed in the bath. The separator paper was pulled up and dried at 90° C. for 5 minutes. It was pressed to yield a separator.

Using the electrodes and the separator obtained, a three-electrode cell shown in FIG. 1 was assembled. A sheet prepared by sheeting activated carbon #1711 in a manner similar to those mentioned above was used as a reference electrode. These cells were dried in a vacuum at 220° C. for 24 hours, and then cooled. An electrolytic solution was prepared by dissolving spirobipyrrolidinium tetrafluoroborate (SBPBF₄) into propylene carbonate to a concentration of 2.0 mol %. The resulting electrolytic solution was poured into the cell to produce an electric double layer capacitor.

A charge-and-discharge tester “CDT-RD20” manufactured by Power Systems Co., Ltd. was connected to the assembled electric double layer capacitor, which was thereby subjected to an electric activation. Then, while the ambient temperature was kept at 25° C., constant-current charging at 5 mA was conducted for 7200 seconds. After arrival at a preset voltage, constant-current discharging at 5 mA was conducted. Using a preset voltage of 4.2 V, three cycles of operation was carried out and the data of the third cycle were adopted.

The capacitance (F/cc) was calculated from the discharged power.

The direct current resistance (Ω) was calculated from the IR drop during the constant-current discharging.

Subsequently, the ambient temperature was raised up to 70° C. and 100 cycles of charging/discharging under the above-mentioned conditions were conducted. Then, the ambient temperature was returned down to 25° C., followed by three cycles of charging/discharging and measurement of the capacitance retention was conducted. Thus, the internal resistance increase ratio (%) was calculated by the following formula. Table 1 is a table showing the capacitance retention (%) and the internal resistance increase ratio (%) after 106 cycles of the electric double layer capacitor.

### Example 2

An electric double layer capacitor was produced and tested in a manner similar to Example 1 except using a latex “XSBR-0696” produced by JSR Corp. instead of the latex “BM-400B” produced by Nippon Zeon Co., Ltd. The test results are shown in Table 1.

### Comparative Example 1

An electric double layer capacitor was produced and tested in a manner similar to Example 1 except using a TF paper produced by NKK Corp. (Nippon Kodoshi Corp.) as a separator. The test results are shown in Table 1.

TABLE 1

| | Capacitance retention | Internal resistance increase |
|---|---|---|
| | (%) after 106 cycles | ratio (%) after 106 cycles |
| Example 1 | 80 | 90 |
| Example 2 | 78 | 95 |
| Comparative | 30 | 550 |
| Example 1 | | |

Capacitance retention (%) = C106/C3 × 100
Resistance increase ratio (%) = (R106/R3-1) × 100
C3: capacitance after 3 cycles (25° C.), C106: capacitance after 106 cycles (25° C.)
R3: resistance after 3 cycles (25° C.), R106 resistance after 106 cycles (25° C.)

According to the results of the Examples, electric double layer capacitors using a separator for insulating a positive electrode and a negative electrode of the present invention are superior to ones using paper material as a separator in durability (resistance stability) in a high temperature environment.

What is claimed is:

1. A separator for insulating a positive electrode and a negative electrode, obtainable by impregnating a porous sheet containing cellulose selected from the group consisting of paper and mixed paper with an acid-modified latex.

2. The separator according to claim 1, wherein the acid-modified latex contains, as an ingredient thereof, a rubber selected from the group consisting of NBR, SBR, acrylic rubber, fluororubber and IIR.

3. The separator according to claim 1, wherein the acid-modified latex comprises a polymer resulting from polymerization using an acidic monomer.

4. A process for preparing a separator for insulating a positive electrode and a negative electrode comprising:
impregnating a porous sheet containing cellulose selected from the group consisting of paper and mixed paper with an acid-modified latex.

5. The process according to claim 4, wherein the acid-modified latex contains, as an ingredient thereof, a rubber selected from the group consisting of NBR, SBR, acrylic rubber, fluororubber and IIR.

6. The process according to claim 4, wherein the acid-modified latex comprises a polymer resulting from polymerization using an acidic monomer.

7. An electric double layer capacitor comprising a carbonaceous positive electrode, the separator for insulating a positive electrode and a negative electrode according to claim 1, and a carbonaceous negative electrode, which are soaked in an electrolytic solution comprising a nonaqueous solvent and a solute dissolved therein.

8. The electric double layer capacitor according to claim 7, wherein at least one of the carbonaceous positive electrode and the carbonaceous negative electrode is a nonporous carbonaceous electrode comprising graphite-like microcrystalline carbon.

9. The electric double layer capacitor according to claim 7, wherein the carbonaceous positive electrode and the carbonaceous negative electrode are nonporous carbonaceous electrodes comprising graphite-like microcrystalline carbon.

10. The electric double layer capacitor according to claim 7, wherein the solute is at least one electrolyte selected from the group consisting of a tetrafluoroborate salt of an quaternary ammonium and its derivatives, and a hexafluorophosphate salt of an quaternary ammonium and its derivatives.

11. The electric double layer capacitor according to claim 10, wherein the quaternary ammonium is the pyrrolidinium compound represented by the formula: 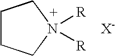
wherein R is each independently an alkyl group having from 1 to 10 carbon atoms or R and R form together an alkylene group having 3 to 8 carbon atoms.
